(19) United States
(12) Patent Application Publication
(10) Pub. No.: US 2026/0266346 A1
(43) Pub. Date: Sep. 10, 2026

(54) SYSTEM AND METHOD FOR ONLINE BRAKE PAD CONTACT ESTIMATION

(71) Applicant: HL MANDO CORPORATION, Gyeonggi-do (KR)

(72) Inventors: Manoj Kumar Reddy MOTAKATLA, Auburn, MI (US); Raja RAMAKRISHNAN, Auburn, MI (US); Jeremy DOBBS, Auburn, MI (US); Bhuvaneswari VISHNUSHANKAR, Auburn, MI (US); Jonathon HANNAHS, Auburn, MI (US)

(21) Appl. No.: 19/073,921

(22) Filed: Mar. 7, 2025

(51) Int. Cl. F16D 65/56; B60T 1/06; B60T 13/74; F16D 65/38; F16D 121/24; F16D 125/40; H02P 3/04

(52) U.S. Cl. CPC F16D 65/567; B60T 1/065; B60T 13/746; H02P 3/04; F16D 2065/386; F16D 2121/24; F16D 2125/40

(57) ABSTRACT

An electromechanical brake (EMB) assembly includes: a brake rotor that rotates with a wheel of a vehicle; a brake pad assembly that engages with the brake rotor; an actuator assembly including a motor and a translatable mechanism, the motor being configured to mechanically move the brake pad assembly toward or away from the brake rotor using the translatable mechanism; and an electronic control unit (ECU) coupled to the actuator assembly, the ECU including a processor coupled to a memory and is configured to monitor and determine an online pad contact position between the translatable mechanism and the brake pad assembly during a braking cycle of the vehicle.

### BACKGROUND

Various embodiments of the present disclosure generally relate to an electromechanical brake system and more particularly to a system and method for controlling a parking brake of the electromechanical brake system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” and electric or “brake by wire.” For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) assembly may comprise: a brake rotor that rotates with a wheel of a vehicle; a brake pad assembly that engages with the brake rotor; an actuator assembly comprising a motor and a translatable mechanism, the motor being configured to mechanically move the brake pad assembly toward or away from the brake rotor using the translatable mechanism; and an electronic control unit (ECU) coupled to the actuator assembly, the ECU comprising a processor coupled to a memory and is configured to monitor and determine an online pad contact position between the translatable mechanism and the brake pad assembly during a braking cycle of the vehicle.

The ECU is configured to use the online pad contact position to adjust a position of the translatable mechanism relative to the brake pad assembly, the position being used during non-braking cycles of the vehicle.

The ECU uses at least a motor velocity of the motor to determine a current pad contact position between the brake pad assembly and the translatable mechanism, the current pad contact position being used as the online pad contact position.

The motor velocity is filtered by the ECU using an adaptive filter to obtain a filtered motor velocity, and the filtered motor velocity is used by the ECU to obtain an estimated acceleration of the motor.

The ECU further uses the filtered motor velocity and the estimated acceleration to determine whether system dynamics of the actuator assembly is within a linear range.

The ECU only performs determination of the online pad contact position when the system dynamics of the actuator assembly is within the linear range.

The online pad contact position is further determined by the ECU using force command data, the force command data indicating whether a current braking cycle of the vehicle is a normal braking cycle or an abnormal braking cycle.

The ECU ignores the current braking cycle for determining the online pad contact position when the force command data indicates that the current braking cycle is an abnormal braking cycle.

The ECU further: determines whether a difference between the current pad contact position and a previously determined pad contact position is greater than a predetermined threshold; in response to the difference being greater than the predetermined threshold, uses the previously determined pad contact position as the online pad contact position instead of the current pad contact position; and in response to the difference not being greater than the predetermined threshold, uses the current pad contact position as the online pad contact position.

The online pad contact position changes after one or more instances of the braking cycle as a brake pad of the brake pad assembly wears down from being actuated by the translatable mechanism.

The ECU uses the online pad contact position to adjust a position of the translatable mechanism to prevent drag caused by unintentional contact between the translatable mechanism and the brake pad outside of the braking cycle of the vehicle.

During the braking cycle, the translatable mechanism travels a linear position before coming into contact with the brake pad assembly, a point at which the translatable mechanism contacts the brake pad assembly being a home position of the translatable mechanism, and the home position being used to determine the online pad contact position.

The linear position corresponds to an air gap that exists between the translatable mechanism and the brake pad assembly outside of the braking cycle of the vehicle.

The ECU manipulates an actual torque command to keep a motor torque of the motor constant during the determination of the online pad contact position.

A constant magnitude of the motor torque is adjusted by the ECU as a function as a motor temperature of the motor.

The ECU determines the online pad contact position only after determining that a set of conditions have been satisfied.

The set of conditions comprises a motor velocity region check, a motor acceleration region check, a braking force region check, and torque command check.

The ECU uses the online pad contact position to determine a current position of a brake pad of the brake pad assembly relative to the translatable mechanism, the brake pad being one of two brake pads making up the brake pad assembly, and the brake pad being a closest of the two brake pads to the translatable mechanism.

The ECU uses the current position of the brake pad relative to the translatable mechanism to adjust an air gap value of a current air gap that exists between the brake pad and the translatable mechanism outside of the braking cycle of the vehicle.

According to some embodiments of the present disclosure, a method comprise: determining, by an electronic control unit (ECU) of an electromechanical brake (EMB) assembly, an online pad contact position between a translatable mechanism and a brake pad assembly of the EMB assembly during a braking cycle of a vehicle on which the EMB is installed, wherein the EMB assembly comprises: a brake rotor that rotates with a wheel of a vehicle on which the EMB assembly is installed; the brake pad assembly that engages with the brake rotor; and an actuator assembly comprising a motor and the translatable mechanism, the motor being configured to mechanically move the brake pad assembly toward or away from the brake rotor using the translatable mechanism; and using, by the ECU, the online pad contact position to adjust a position of the translatable mechanism relative to the brake pad assembly.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1A is a cross-sectional view of a brake assembly according to an exemplary embodiment of the present disclosure.

FIG. 1B is a diagram showing an interaction between a brake pad assembly and a translatable mechanism of the brake assembly of FIG. 1A.

FIG. 2 is a block diagram for showing a method of controlling the brake assembly according to an exemplary embodiment of the present disclosure.

FIG. 3 is an implementation example of an exemplary embodiment of the present disclosure.

FIG. 4 is a flowchart of a method for controlling the brake assembly according to an exemplary embodiment of the present disclosure.

FIG. 5 is a schematic view of a vehicle including a steering system and a brake assembly according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

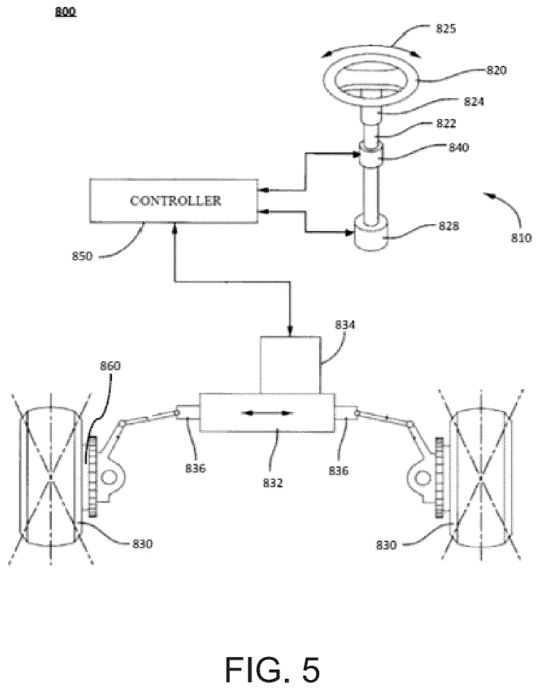

A vehicle (see, e.g., FIG. 5) is equipped with a parking brake to prevent movement of wheels when the vehicle is not in operation, for instance, when the vehicle is stopped or parked. The parking brake may refer to a mechanism for restraining or holding a parked vehicle in place. The parked status of the vehicle can be maintained by a parking lock mechanism, for example, but not limited to, a strut, a parking pawl, engagement of one or more gears, and so on. A reliable parking brake operation is particularly important for safety. However, when the vehicle is not in operation, as when the parking brake is needed, the parking brake may be accidentally disengaged or released. For instance, the parking brake may not provide a force sufficient to clamp brake pads to prevent rolling of the vehicle, or the parking lock mechanism may not be appropriately engaged. A brake control system for controlling the parking brake needs to be designed to assure that the parking brake remains securely engaged.

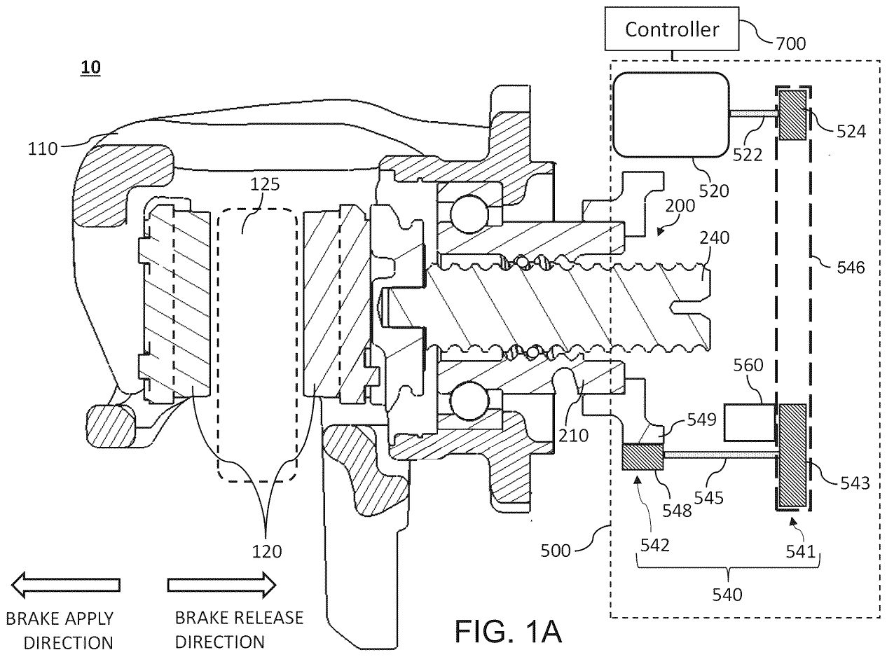

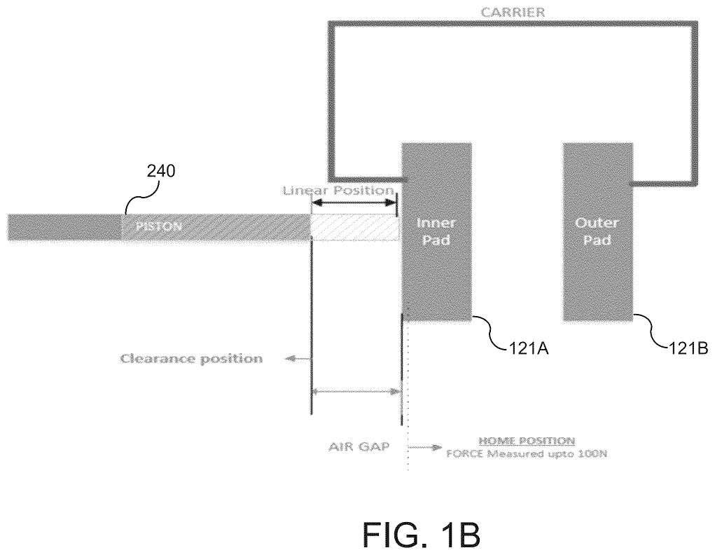

According to some embodiments of the present disclosure, brake pads of a brake assembly's brake pad assembly wear down over time as braking occurs during normal operation of the vehicle. Embodiments herein disclose a system and method for estimating a position (i.e., an online pad contact position) when contact to the brake pads occurs during an active braking instance of the vehicle (i.e., the active braking instance referred to herein as an “online” moment when the pad contact happens). As discussed in more detail below, such a position when contact to the brake pads occurs advantageously provides reference for maintaining an appropriate pad gap between a brake pad (or brake pads) and other mechanical systems of a brake assembly (i.e., brake assembly 10 of FIG. 1A) that actuate the brake pad(s) during braking such that braking-related and/or non-braking-related issues (e.g., over/under braking, drag from unintentional contact with the brake pad(s) during non-braking operations (i.e., outside of braking cycles), or the like) does not occur during normal operation of the vehicle.

In the context of embodiments disclosed herein, the term “online” is used to denote an active braking instance/cycle of the vehicle (e.g., the braking of the vehicle is in an online/active state). The term “online” is not used in connection with its commonly known definition of something being in connection with and/or using the Internet (e.g., being connected to, served by, or available through a system and especially a computer or telecommunications system (such as the Internet)). Thus, the terms “online pad contact” and “online pad contact position” should be understood as being “contact with the brake pad(s) or a contact position (i.e., contact point) on the brake pad(s) by one or more other components of a brake assembly that actuate the brake pad(s) during an active braking instance/cycle of the vehicle on which the brake assembly is installed.

Referring to FIG. 1A, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240 (also referred to herein as a “translatable mechanism”). For example, the rotatable part 210 may comprise a nut or a ball nut and the translatable part 240 may comprise a screw, a ball screw, or a piston, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatably part 210. Alternatively, the electric motor 520 is indirectly connected to the rotatably part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable body 210 of the drive mechanism 200. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of the rotatable body or nut 210 of the drive mechanism or screw-nut mechanism 200 or be mounted to the rotatable body 210 of the drive mechanism 200 to rotate the rotatable body or nut 210.

The mechanical connection between the electric motor 520 and the brake pad assembly 120 described above and illustrated in FIG. 1A is an example for illustration purposes only, and the present disclosure is not limited thereto. Any structure, configuration, and arrangement of the mechanical connection that can mechanically connect the electric motor 520 to the brake pad assemblies 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assemblies 120.

Additionally, if the parking brake is properly engaged by applying sufficient brake clamping force to the rotor 125 of the wheel, the motor torque generated by the electric motor 520 is decreased to allow a parking lock mechanism 560 to prevent moving the brake pad assembly 120 in the release direction. For instance, a strut, a parking pawl or a gear included in the parking lock mechanism 560 may be engaged with any component of the drive mechanism 200 or the actuator assembly 500, such as notches formed on a gear in order to lock the movement of the brake assembly 120. The details of exemplary embodiments of the parking lock mechanism 560 are described in U.S. application Ser. No. 17/579,552, filed on Jan. 19, 2022, and published as U.S. Patent Application Publication No. 2023/0228309 on Jul. 20, 2023, the entire teachings of which are incorporated by reference herein.

Furthermore, the brake assembly 10 may further include a controller 700 that may be configured to control the electric motor 520 to perform the operation of the parking brake such as a parking brake application or a parking brake release. For instance, the controller 700 may control the electric motor 520 by controlling the inverters 511 connected between the power source 510 and the electric motor 520. The controller 700 may be, for example, but not limited to, a micro-controller unit (MCU), a circuit chip, a semiconductor circuit, and a circuit board having memory, one or more processors, and electric components.

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory, one or more processors, and electric components. The controller 700 may be coupled to (e.g., one or more components of) the actuator assembly.

Turning now to FIG. 1B, FIG. 1B shows a diagram illustrating an interaction between the brake pad assembly 120 and the translatable part 240 of the brake assembly 10 of FIG. 1A.

As shown in FIG. 1B, the brake pad assembly 120 may include an inner brake pad 121A and an outer brake pad 121B (also referred to herein simply as “inner pad 121A” and “outer pad 121B”) that are held by a brake pad carrier (or other similar mechanism). The inner pad 121A is separated from the outer pad 121B by a predetermined distance that includes a width of the brake rotor 125 and two clearance distances between the two sides of the brake rotor 125 and each of the inner brake pad 121A and the outer brake pad 121B.

As further shown in FIG. 1B, the translatable part 240 is shown in this example as a piston. This piston may have a linear portion spanning over distance specified by the “linear position” label that defines a length that the piston has to move to come into contact with inner pad 121A during an active braking instance/cycle of the vehicle. This “linear position” of the piston also corresponds to an air gap that exits between the terminal end (or distal end) of the piston and a surface of the inner pad 121A closest to the piston. A “clearance position” is also shown in FIG. 1B as the position the piston retracts to after the braking instance/cycle has ended.

Said another way, during an active braking instance/cycle (i.e., when the braking is online), the piston is actuated by the motor 520 to travel across the air gap (i.e., travel a distance corresponding to the linear position) to come into contact with and push the inner pad 121A against the brake rotor 125 such that the brake rotor is clutched between inner pad 121A and outer pad 121B to stop a rotation of the brake rotor 125 (which in turn stops the rotation of the motor vehicle wheel on which the brake rotor is installed).

During this active braking instance/cycle, the point at which the piston contacts the inner pad 121A to apply enough force to stop the rotation of the brake rotor 125 is referred to as the “home position” shown in FIG. 1B. At this “home position” the piston may assert a force up to 100 Newtons (N) against the inner pad 121A. This “home position” shown in FIG. 1B is also referred to herein as an online pad contact position of the brake assembly/piston during the active brake instance/cycle.

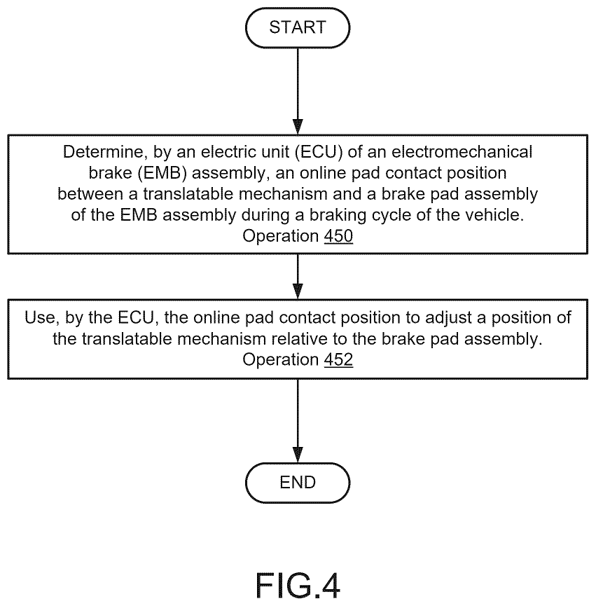

As will be explained in more detail below in FIG. 4, when such pad contact happens at the home position, a motor velocity slope of the motor 520 changes and a motor acceleration of the motor 520 becomes negative. Such readings of the motor velocity slope and the motor acceleration of the motor 520 (e.g., obtained by one or more sensors installed within the brake assembly 10, the one or more sensors being coupled to the controller 700) may advantageously provide the controller 700 with the necessary information to monitor and determine (e.g., estimate) when such pad contact happens.

Such pad contact (i.e., the online pad contact position) in turn advantageously provides the controller 700 with information necessary to understand how much the brake pad(s) (the inner pad 121A and outer pad 121B) has worn down after continuous use in order to maintain the proper air gap (e.g., a distance that prevents drag of the vehicle due to unintentional contact between the piston and inner pad 121A during normal, non-braking instances/cycles of the vehicle) between the piston and the inner pad 121A during normal operation of the vehicle.

Such pad contact may also advantageously be used by the controller 700 to adjust the liner position traveled by the piston to account for the wear on the brake pad(s) such that over and/or under braking can be prevented during an active braking instance/cycle.

However, challenges exist when using such motor velocity slope and the motor acceleration of the motor 520 to estimate the pad contact (i.e., the online pad contact position). For example, the motor velocity slope of the motor 520 changes and the motor acceleration of the motor 520 becomes negative only when a force command of the motor 520 is in a linear region (e.g., a region with no significant fluctuations and/or changes in a currently observed value of the force command). Additionally, the air gap between the piston and the inner pad 121A cannot be too big. Threshold values may be set by one or more manufacturers of these brake assemblies 10 to define what could be an air gap that is too big. For example, based on various factors such as brake size, car size, and other similar vehicle and/or brake ratings, a manufacturer may set (as a non-limiting example) 5 mm as being an air gap that is too big. Although 5 mm is provided as one example here, depending on a specific brake and/or manufacture rating, a big air gap may be an air gap of any size larger than, for example, 1 mm without departing from the scope of embodiments disclosed herein. The speed (e.g., velocity) of the motor 520 also cannot have too much noise. Finally, if a difference between a current instance of the online pad contact position and a previously measured instance of the online pad contact position is too big, the braking instance/cycle may be an abnormal braking instance/cycle (e.g., emergency/panic braking, drag, or the like) that would not allow an accurate determination of the online pad contact position for adjustments to the brake assembly for normal vehicle operation use.

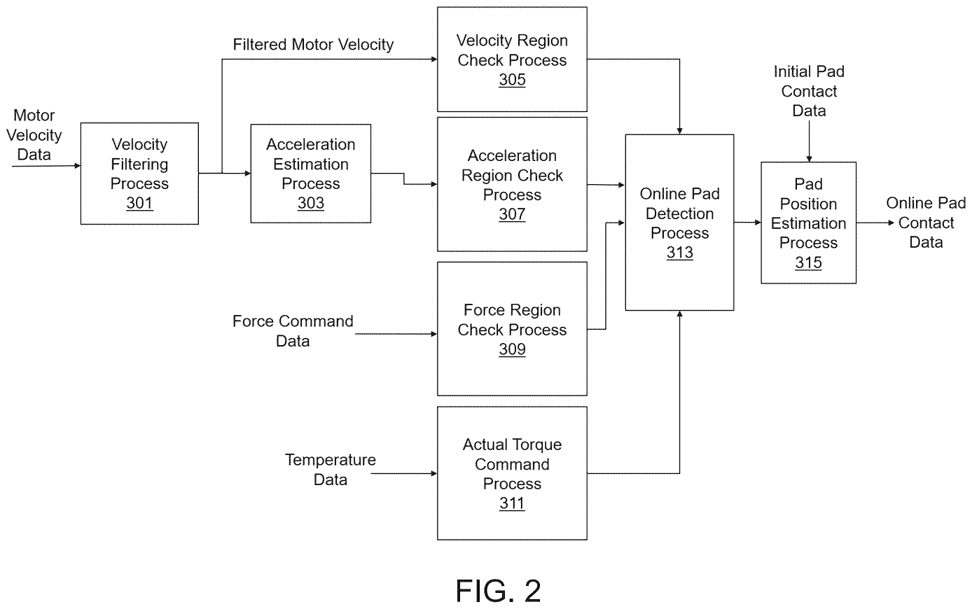

Advantageously, use of such motor velocity slope and the motor acceleration of the motor 520 while overcoming all of the above-discussed challenges to obtain an accurate online pad contact position may be achieved (e.g., realized, accomplished, or the like) using the method in accordance with one or more embodiments herein for controlling a brake assembly discussed below in FIG. 2.

Turning now to FIG. 2, FIG. 2 shows a block diagram for showing a method of controlling the brake assembly according to an exemplary embodiment of the present disclosure. Namely, FIG. 2 shows a method for determining (e.g., estimate) an online pad contact position during an active braking instance/cycle of the vehicle using the brake assembly 10.

As shown in FIG. 2, motor velocity data is obtained (e.g., from motor 520 using one or more sensors installed within brake assembly 10) and provided (i.e., ingested) into velocity filtering process 301. All of the processes discussed below in the method of FIG. 2 may be performed (e.g., executed) by controller 700 of the brake assembly 10.

As part of velocity filtering process 301, the motor velocity data is filtered using an adaptive filter to obtain (as an output of the velocity filtering process 301) a filtered motor velocity. In particular, the adaptive filter filters the motor velocity data (e.g., a motor velocity signal) without creating any phase delays in the motor velocity data. For example, the adaptive filter may be configured to filter the motor velocity data using past and current values of the motor velocity data. A 42-point buffer may be used as part of the adaptive filter to store the velocity and position of the motor 520 and a time at which the velocity and position are measured. Other filter sizes (besides the 42-point buffer) may also be used without departing from the scope of embodiments disclosed herein as long as the filter size is able to effectively filter out noisy signals (e.g., collected by the one or more sensors) from the motor velocity data.

The filtered motor velocity output (e.g., generated) by velocity filtering process 301 may be ingested into acceleration estimate process 303 where the filtered motor velocity is translated (e.g., transformed, converted, or the like) into an acceleration value. Any type of velocity to acceleration conversion process, algorithm, and or equation may be used as part of acceleration estimate process 303 without departing from the scope of embodiments disclosed herein. The acceleration estimate process 303 may generate (e.g., output) a filtered motor acceleration.

Such filtering of the motor velocity data into the filtered motor velocity and the filtered motor acceleration advantageously overcomes the above-discussed challenge of the speed (e.g., velocity) of the motor 520 having too much noise to accurately determine the online pad contact position.

In embodiments, the filtered motor velocity and the filtered motor acceleration may be ingested, respectively, into velocity region check process 305 and acceleration region check process 307. As part of velocity region check process 305 and acceleration region check process 307 the controller may perform one or more processes to determine whether system dynamics (e.g., of the motor 520) within a linear range. For example, the velocity region check process 305 ensures that the controller 700 is able to identify when the brake pad(s) are actually touching/within the airgap (namely, inner pad 121A of FIG. 1B is actually touching the air gap existing between the inner pad 121A and the piston). The acceleration region check process 307 ensures that the filtered motor acceleration has become negative, which is an indication that the translatable part 240 of the brake assembly 10 is in contact with the brake pad(s).

The velocity region check process 305 and acceleration region check process 307 may be performed by controller 700 by the controller 700 mapping out the filtered motor velocity and the filtered motor acceleration onto a graph (e.g., a physical or virtual graph) similar to that shown in FIG. 4. In particular, the controller 700 may track the changes in the filtered motor velocity and the filtered motor acceleration until the controller 700 determines that the brake pad(s) are actually touching/within the airgap and when the filtered motor acceleration has become negative.

In embodiments, only when both of these conditions (i.e., the brake pad(s) are actually touching/within the airgap and when the filtered motor acceleration has become negative) have occurred will the controller 700 determine that the system dynamics are within the linear range. In particular, when the system dynamics is not in the linear range, contact between the translatable part 240 and the brake pad(s) is either ignored and/or falsely detected, which will negatively affect the accuracy of the estimated online pad detection position by the controller 700. As a result, ensuring that the system dynamics are in the linear range overcomes the challenge not knowing whether a force command of the motor 520 is in a linear region and the challenge of the air gap being too big.

Said another way, in one or more embodiments, the controller 700 will only estimate the online pad contact position when the two conditions associated with the velocity region check process 305 and the acceleration region check process 307 have been met (i.e., the motor velocity data passes both the velocity region check process 305 and the acceleration region check process 307).

In addition to the velocity region check process 305 and the acceleration region check process 307, the controller 700 may perform (e.g., execute) additional checks to confirm that the current braking instance/cycle is a normal braking instance/cycle in which the controller 700 is able to estimate (e.g., determine) an accurate value for the online pad contact position. These additional checks further ensure that the above-discussed challenges can be overcome such that the controller 700 estimates (e.g., determines) an accurate online pad contact position to be used to adjustment to the brake assembly to more effectively and accurately prevent braking-related and/or non-braking-related issues (e.g., over/under braking, drag from unintentional contact with the brake pad(s) during non-braking operations, or the like) during normal vehicle operation use

In embodiments, one such additional check is the force region check process 309. The force region check process 309 obtains force command data to ensure that the online pad contact position only obtained only during normal braking instances/cycles and not during abnormal braking instances/cycles (e.g., panic breaking, parking cycle, drag adjustment, or the like). Similar to the motor velocity data, the force command data may be measured by one or more sensors (e.g., a force sensor or the like) installed within brake assembly 10. The sensor(s) may be installed in the proximity of the brake pad assembly 120 in order to measure the force exerted on the inner pad 121A during contact by the inner pad 121A with the translatable part 240.

More specifically, if contact detection between the translatable part 240 and the brake pad(s) happens when the measured force (e.g., the force command data) is not applied very fast, the force command data passes the force region check process 309. One of ordinary skill would appreciate that the force threshold for determining whether the measured force is not applied very fast (e.g., to determine whether the current braking instance/cycle is a normal or abnormal one) may differ based on the size and capabilities (i.e., force ratings) of the brake assembly 10 and/or the vehicle on which the brake assembly 10 is installed. Therefore, the force region check process 309 may be configured using any force threshold suitable for the type of brake assembly 10 and/or vehicle for which the method of embodiments disclosed herein is being implemented without departing from the scope of embodiments disclosed herein. For example, a force threshold suitable for compact cars may be applied to the force region check process is the vehicle is a (non-sport modified) sedan or the like.

In embodiments, another such additional check to be passed before the controller 700 determines that it should estimate the online pad contact position may be the actual torque command process 311. As part of actual torque command process 311, temperature data of the motor 520 may be obtained and ingested by the controller 700. The temperature data may be measured by one or more sensors (e.g., temperature sensors, or the like) installed in the brake assembly 10 of FIG. 1A within close proximity to the motor 520 (i.e., any distance where the sensor(s) are able to accurately measure the operating temperature of the motor 520).

Using the temperature data, a constant magnitude of a motor torque for the motor 520 may be obtained and/or adjusted based on a function of the temperature data. One of ordinary skill in the art would appreciate that any techniques, algorithms, equations, or the like that can be used to obtain torque based on a function of the temperature data may be applied to embodiments herein without departing from the scope of one or more embodiments disclosed herein. In particular, a torque command issued by the controller 700 to the motor 520 may be adjusted using the constant magnitude of the motor torque to ensure that, during the online pad contact position estimation/determination by the controller 700, the motor torque of the motor 520 is kept constant (i.e., is not changed).

In embodiments, a value of the constant magnitude of the motor torque may vary based on the size and capabilities (i.e., the ratings) of the motor 520, the other components of the brake assembly 10, and/or of the vehicle. Thus, any value of the constant magnitude for the motor torque may be used without departing from the scope of embodiments disclosed herein as along as the value has been determined to be suitable to the motor 520, the other components of the brake assembly 10, and/or of the vehicle.

In embodiments, once all (or a specific predetermined set of) the checks (i.e., the velocity region check process 305, the acceleration region check process 307, the force region check process 309, and the actual torque command process 311) have been passed, the controller 700 determines (e.g., as part of online pad detection process 313) that the current braking instance/cycle is a normal braking instance/cycle for which the online pad detection position should be estimated/determined. As a result, controller 700 may use the filtered motor velocity and the filtered motor acceleration to determine the instance during which the online pad contact has occurred to then calculate the online pad contact position at which the translatable part 240 of the brake assembly 10 contacts the inner pad 121A at the home position shown in FIG. 1B.

This online pad contact position may further be used by the controller 700 to calculate the air gap (i.e., the linear position to be traveled by the translatable part 240) between the current clearance position of the translatable part 240 and the inner pad 121A (e.g., see FIG. 1B). The air gap may then be used by the controller 700 (e.g., by comparing a currently determined air gap value to a previously determined air gap value) to determine whether the air gap has increased due to wear and tear of the inner pad 121A and/or the outer pad 121B.

The linear position may be estimated (e.g., determined) by measuring a total movement of the motor 520 between a start of the braking instance/cycle to when the controller 700 determines that the translatable part 240 has contacted the inner pad 121A at the home position (e.g., as determined based on the filtered motor velocity and filtered motor acceleration). The total movement of the motor 520 may then be used to calculate (e.g., based on one or more predetermined equations based on the size and other ratings of the motor 520) the linear position traveled by the translatable part 240 before reaching the home position (see e.g. FIG. 1B).

In embodiments, before the online pad contact position estimated (e.g., determined) in online pad detection process 313 is used to determine the linear position, the online pad contact position may be compared to an initial pad contact data as part of pad position estimation process 315.

More specifically, the online pad contact position estimated in a currently happening braking instance/cycle (referred to herein as the “currently estimated (e.g., determined) online pad contact position) may be compared to the online pad contact position estimated in an immediately previous instance of the braking instance/cycle (referred to herein as the “initial pad contact data”). If a difference (e.g., an absolute value difference or the like) between the two online pad contact position is greater than a predetermined threshold (e.g., a threshold set by a manufacturer of the brake assembly 10 and/or the vehicle), the currently estimated (e.g., determined) online pad contact position will be ignored. Alternatively, if the difference is less than the predetermined threshold, the currently estimated (e.g., determined) online pad contact position will be used and will replace (e.g., update) the online pad contact position estimated in an immediately previous instance of the braking instance/cycle as the new initial pad contact data. Such comparison of the difference advantageously allows the controller 700 of the brake assembly to determine whether the difference indicates an abnormally quick wearing of the brake pad(s), which is not expected to happen in a real-world operation of the vehicle.

Said another way, if the difference is greater than the threshold, the currently estimated (e.g., determined) online pad contact position will be ignored because it is determined to be inaccurate.

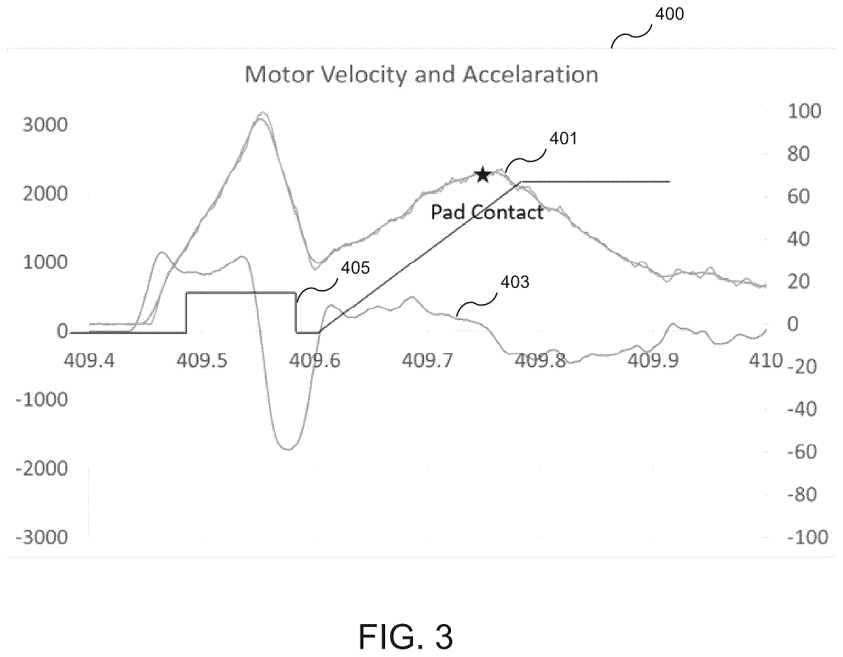

Turning now to FIG. 3, FIG. 3 shows a graph showing how the online pad contact/online pad contact position may be estimated (e.g., determined) by the controller 700 using the filtered motor velocity and the filtered motor acceleration. One of ordinary skill would appreciate that the graph in FIG. 3 is provided strictly for visualization purposes only and the controller 700 may not actually generate such a graph when estimating (e.g., determining) the online pad contact/online pad contact position during a real-time operation of the vehicle.

As shown in the graph 400 of FIG. 3, when a large (e.g., significant) change in the motor velocity profile 401 is observed (e.g., between the 409.5 and 409.6 mark on the x-axis, which denotes a passage of time), the brake assembly 10 (namely through controller 700) may determine (e.g., using the method discussed above in reference to FIG. 2) that the current braking instance/cycle of the vehicle is one that is suitable for determining the online pad contact position for the brake assembly 10. As a result, the point when the translatable part 240 contacts the inner pad 121A can be estimated and/or determined within a predetermined threshold when contact detection conditions (e.g., the conditions identified in any combinations of the velocity region check process 305, the acceleration region check process 307, the force region check process 309, and/or the actual torque command process 311 discussed above in reference to FIG. 2) are satisfied. For example, the acceleration 403 of the vehicle may be checked for a large negative deceleration (e.g., again between the 409.5 and 409.6 mark on the x-axis) that indicates the vehicle is braking. Further, a force command value 405 may be checked to determine whether a driver of the vehicle is intentionally causing the brake assembly 10 to apply a large amount of force over a short period of time (e.g., is actually conducting a braking of the vehicle, which is illustrated as the sudden increase in force between 409.6 and 409.8 on the x-axis). Once the translatable part 240 fully presses against inner pad 121A (e.g., during an online pad contact position of the braking cycle/instance), the force command value 405 may start to level off and become constant (e.g., after around 409.8 on the x-axis of graph 400) until the contact between the translatable part 240 fully presses against inner pad 121A is removed.

Turning now to FIG. 4, FIG. 4 is a flowchart of a method for controlling the brake assembly according to an exemplary embodiment of the present disclosure.

Starting at Operation 450, and as discussed above in reference to FIGS. 1A-3, an electric unit (ECU) (e.g., controller 700 of FIG. 1A) of an electromechanical brake (EMB) assembly (e.g., brake assembly 10 of FIG. 1A) may determine an online pad contact position between a translatable mechanism (e.g., translatable part 240 of FIG. 1A) and a brake rotor of the EMB assembly during a braking cycle of the vehicle.

In Operation 452, and as already discussed above in reference to FIGS. 1A-3, the ECU may use the online pad contact position to adjust a position of the translatable mechanism relative to the brake pad assembly. For example, the ECU may use the online pad contact position to adjust a linear position traveled by the translatable mechanism before the translatable mechanism comes into contact with one or more brake pads of the brake pad assembly.

Such adjustments by the ECU using the online pad contact position may advantageously prevent braking-related and/or non-braking-related issues (e.g., over/under braking, drag from unintentional contact with the brake pad(s) during non-braking operations, or the like) during normal operation of the vehicle installed with one or more of the EMB.

Any of the above-discussed motor vehicles according to certain exemplary embodiments of the present disclosure may be identical, or substantially similar to, vehicle 800 shown in FIG. 5. The vehicle 800 may be any passenger or commercial automobile such as a hybrid vehicle, an electric vehicle, or any other type vehicles. FIG. 5 is a schematic view of a vehicle 800 including a steering system and a brake assembly according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 5 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

The electric motor can also be employed in an electromagnetic brake assembly 860. The electromagnetic brake assembly 860 is configured to cause the road wheel 830 to slow or stop motion using electromagnetic force to apply mechanical resistance or friction by using the torque generated by the electric motor.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) assembly comprising:
a brake rotor that rotates with a wheel of a vehicle;
a brake pad assembly that engages with the brake rotor;
an actuator assembly comprising a motor and a translatable mechanism, the motor being configured to mechanically move the brake pad assembly toward or away from the brake rotor using the translatable mechanism; and
an electronic control unit (ECU) coupled to the actuator assembly, the ECU comprising a processor coupled to a memory and is configured to monitor and determine an online pad contact position between the translatable mechanism and the brake pad assembly during a braking cycle of the vehicle.

2. The EMB assembly of claim 1, wherein the ECU is configured to use the online pad contact position to adjust a position of the translatable mechanism relative to the brake pad assembly, the position being used during non-braking cycles of the vehicle.

3. The EMB assembly of claim 1, wherein the ECU uses at least a motor velocity of the motor to determine a current pad contact position between the brake pad assembly and the translatable mechanism, the current pad contact position being used as the online pad contact position.

4. The EMB assembly of claim 3, wherein the motor velocity is filtered by the ECU using an adaptive filter to obtain a filtered motor velocity, and the filtered motor velocity is used by the ECU to obtain an estimated acceleration of the motor.

5. The EMB assembly of claim 4, wherein the ECU further uses the filtered motor velocity and the estimated acceleration to determine whether system dynamics of the actuator assembly is within a linear range.

6. The EMB assembly of claim 5, wherein the ECU only performs determination of the online pad contact position when the system dynamics of the actuator assembly is within the linear range.

7. The EMB assembly of claim 3, wherein the online pad contact position is further determined by the ECU using force command data, the force command data indicating whether a current braking cycle of the vehicle is a normal braking cycle or an abnormal braking cycle.

8. The EMB assembly of claim 7, wherein the ECU ignores the current braking cycle for determining the online pad contact position when the force command data indicates that the current braking cycle is an abnormal braking cycle.

9. The EMB assembly of claim 3, wherein the ECU further:
determines whether a difference between the current pad contact position and a previously determined pad contact position is greater than a predetermined threshold;
in response to the difference being greater than the predetermined threshold, uses the previously determined pad contact position as the online pad contact position instead of the current pad contact position; and
in response to the difference not being greater than the predetermined threshold, uses the current pad contact position as the online pad contact position.

10. The EMB assembly of claim 1, wherein the online pad contact position changes after one or more instances of the braking cycle as a brake pad of the brake pad assembly wears down from being actuated by the translatable mechanism.

11. The EMB assembly of claim 10, wherein the ECU uses the online pad contact position to adjust a position of the translatable mechanism to prevent drag caused by unintentional contact between the translatable mechanism and the brake pad outside of the braking cycle of the vehicle.

12. The EMB assembly of claim 1, wherein, during the braking cycle, the translatable mechanism travels a linear position before coming into contact with the brake pad assembly, a point at which the translatable mechanism contacts the brake pad assembly being a home position of the translatable mechanism, and the home position being used to determine the online pad contact position.

13. The EMB assembly of claim 12, wherein the linear position corresponds to an air gap that exists between the translatable mechanism and the brake pad assembly outside of the braking cycle of the vehicle.

14. The EMB assembly of claim 1, wherein the ECU manipulates an actual torque command to keep a motor torque of the motor constant during the determination of the online pad contact position.

15. The EMB assembly of claim 14, wherein a constant magnitude of the motor torque is adjusted by the ECU as a function as a motor temperature of the motor.

16. The EMB assembly of claim 1, wherein the ECU determines the online pad contact position only after determining that a set of conditions have been satisfied.

17. The EMB assembly of claim 16, wherein the set of conditions comprises a motor velocity region check, a motor acceleration region check, a braking force region check, and torque command check.

18. The EMB assembly of claim 1, wherein the ECU uses the online pad contact position to determine a current position of a brake pad of the brake pad assembly relative to the translatable mechanism, the brake pad being one of two brake pads making up the brake pad assembly, and the brake pad being a closest of the two brake pads to the translatable mechanism.

19. The EMB assembly of claim 18, wherein the ECU uses the current position of the brake pad relative to the translatable mechanism to adjust an air gap value of a current air gap that exists between the brake pad and the translatable mechanism outside of the braking cycle of the vehicle.

20. A method comprising:
determining, by an electronic control unit (ECU) of an electromechanical brake (EMB) assembly, an online pad contact position between a translatable mechanism and a brake pad assembly of the EMB assembly during a braking cycle of a vehicle on which the EMB is installed, wherein the EMB assembly comprises:
a brake rotor that rotates with a wheel of a vehicle on which the EMB assembly is installed;
the brake pad assembly that engages with the brake rotor; and
an actuator assembly comprising a motor and the translatable mechanism, the motor being configured to mechanically move the brake pad assembly toward or away from the brake rotor using the translatable mechanism; and
using, by the ECU, the online pad contact position to adjust a position of the translatable mechanism relative to the brake pad assembly.
